(19) United States
(12) Patent Application Publication
(10) Pub. No.: US 2013/0318215 A1
(43) Pub. Date: Nov. 28, 2013

(54) SERVER, MANAGEMENT SERVER, METHOD OF SETTING NETWORK DEVICE IN COMPUTER SYSTEM

(71) Applicant: HITACHI, LTD., Tokyo (JP)

(72) Inventor: Sachie TAJIMA, Yokohama (JP)

(73) Assignee: HITACHI, LTD., Tokyo (JP)

(21) Appl. No.: 13/898,797

(22) Filed: May 21, 2013

(30) Foreign Application Priority Data
May 22, 2012 (JP) 2012-116126

(51) Int. Cl. H04L 12/24

(52) U.S. Cl. CPC H04L 41/08
USPC 709/220

(57) ABSTRACT

In the case of switching the current server to a new server, the redundant configuration of the network devices in the current server is inherited. In the case of transferring a system on a transfer source server, which includes a plurality of network devices provided with a redundant setting, from the transfer source server to a virtual server of the new server, a virtualization system of the new server obtains unshared information of making the plurality of network devices of the transfer source unshared, and then makes the plurality of virtual network devices of the new server correspond separately to the plurality of network devices provided to the new server with reference to the unshared information obtained.

### CLAIM FOR PRIORITY

The present application claims priority from Japanese patent application JP 2012-116126 filed on May 22, 2012, the content of which is hereby incorporated by reference into this application.

### BACKGROUND OF THE INVENTION

1. Field of the Invention

The present invention relates to a server, a management server, and a method of setting a network device in a computer system.

2. Description of the Related Art

As the related art of the present technological field, there can be cited JP-A-2009-70142 (Document 1). This publication describes “information of a first logical resource to be accessed by a first virtual computer is obtained, setting information, which is to be set to a physical adapter of the first physical computer in order to get access from the first virtual computer to the logical resource, is obtained, the setting information is set to a physical adapter of the second physical computer, second logical resources, which can be accessed when the second physical computer performs the first virtual computer, are enumerated, and whether or not the second physical computer can perform the first virtual computer is determined by comparing the first logical resource and the second logical sources with each other” (see the abstract).

Document 1 lacks such a deep description as the method of making another server (a new server) inherit the redundant configuration of a network device of a current server in the case of transferring a system established on the current server to a virtual server included in the new server.

For example, there is assumed the case in which the current server and the new server are each equipped with a plurality of network devices, a virtual server is made to operate on a virtualization system of the new server, and a system on the current server is transferred to the virtual server. It is assumed that the system on the current server makes the network devices included in the current server redundant.

When the virtual server on the new server requests a plurality of virtual network devices to the virtualization system, there is a possibility that the virtualization system allocates a plurality of virtual network devices to a single network device and then provides the virtual server with the plurality of virtual network devices. On this occasion, since the plurality of virtual network devices of the virtual server is allocated to the same network device, and is not made redundant, if failures occur in the network device, failures occur in the plurality of virtual network devices made to correspond to the network device.

In the case of switching the current server to the new server, in order to make the redundant configuration of the network device in the current server be inherited, it is required for the management to obtain unshared information for making the network device, which has been set to be redundant in the current server, be unshared. Further, it is required for the new server as the transfer destination to allocate a plurality of virtual network devices to different network devices with reference to the unshared information.

### SUMMARY OF THE INVENTION

In order to solve the problems described above, a server according to an aspect of the invention includes a CPU, a plurality of network devices, and a virtualization system adapted to obtain unshared information including identifiers used to identify a first network device and a second network device provided with a redundant setting provided to a transfer source server, and making the first and second network devices unshared, adapted to set the identifiers used to identify the first and second network devices as identifiers of a first virtual network device and a second virtual network device provided to a virtual server including a plurality of virtual network devices with reference to the unshared information obtained, and adapted to make the first and second virtual network devices, to which the identifiers are set, correspond separately to the network devices.

Further, a management server according to another aspect of the invention includes a memory adapted to store an operating system, and a CPU adapted to perform a configuration management system which transfers the operating system to a first server and then makes the operating system operate in response to receiving a request to transfer a system, which operates in the first server including a first network device and a second network device provided with a redundant setting, to a virtual server established on a second server, obtains unshared information including identifiers of the first and second network devices, and making the first and second network devices unshared, and transmits the unshared information obtained to the second server.

Since the unshared information of making the network devices provided with the redundant setting in the current server unshared is obtained, it is possible to make the new server inherit the redundant configuration of the network devices in the current server. Problems to be solved, configurations, and advantages other than those described above will be disclosed in the following description.

### BRIEF DESCRIPTION OF THE DRAWINGS

FIG. 1 is a configuration diagram showing an example of a computer system.

FIG. 2 is a configuration diagram of a server.

FIG. 3 is a configuration diagram of a management server.

FIG. 4 is a diagram showing an example of unshared information and segment information.

FIG. 5 is a configuration diagram of a special OS.

FIG. 6 is a diagram showing an example of a redundant information list and a segment information list.

FIG. 7 is a configuration diagram of a physical server.

FIG. 8 is a diagram showing an example of an IP list and a connectivity list.

FIG. 9 is a flowchart of a shut down process of a backup target server executed by a configuration management system.

FIG. 10 is a flowchart of a network configuration acquisition process executed by a configuration information acquisition system.

FIG. 11 is a flowchart of a network configuration acquisition process executed by a configuration management system.

FIG. 12 is a flowchart of a network configuration acquisition process executed by the configuration management system and a configuration operation system.

FIG. 13 is a connectivity list generation flowchart executed by the configuration operation system.

FIG. 14 is a flowchart of a network setting process of a restoration destination environment executed by the configuration operation system.

### DETAILED DESCRIPTION OF THE INVENTION

### Description of the Preferred Embodiments

Hereinafter, an embodiment of the invention will be described with reference to the accompanying drawings.

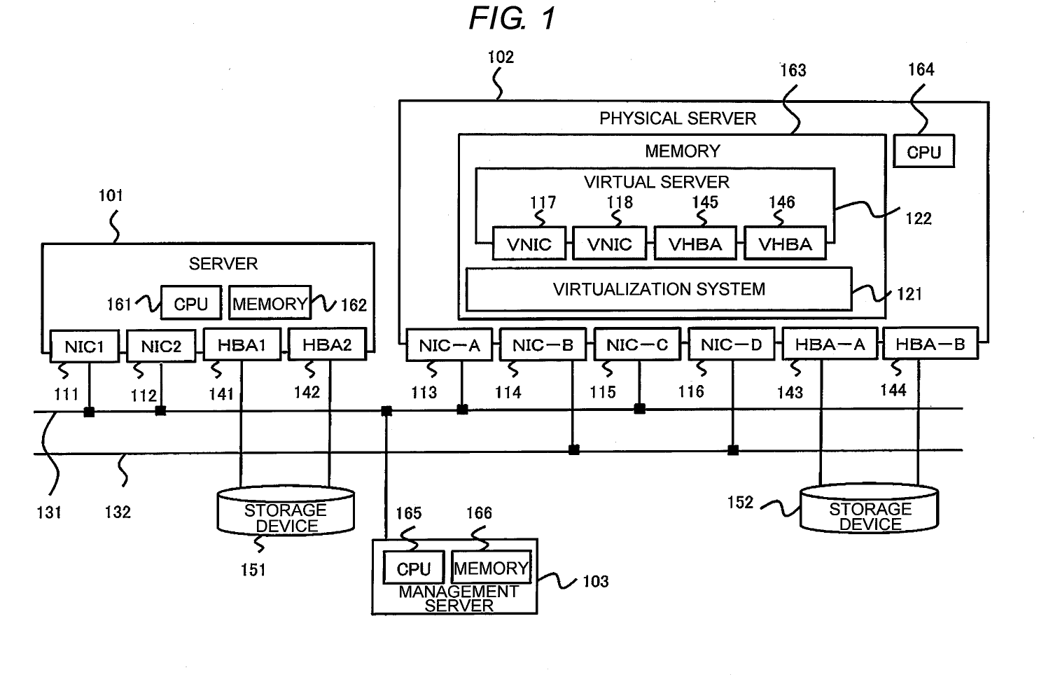

FIG. 1 is a block diagram showing an overall configuration of a computer system. The computer system includes a server 101, a physical server 102, a network segment 131 to which the server 101 and the physical server 102 are connected, a network segment 132 to which the physical server is connected, and a management server 103 which can access the server 101 and the physical server 102. It should be noted that the server 101 can be a physical server or a virtual server.

The server 101 is equipped with a CPU 161, a memory 162, and a plurality of network devices. In the present embodiment, network interface cards (NIC) 111, 112 are installed as the network devices. The NIC 111 and the NIC 112 are identified with device identifiers NIC1 and NIC2, respectively. Further, the server 101 is identified with a server identifier A.

The physical server 102 includes a memory 163, a CPU 164, a plurality of network devices, a virtualization system 121, a virtual server 122 operating on the virtualization system 121, and a plurality of virtual network devices installed in the virtual server 122.

In the present embodiment, the NICs 113, 114, 115, and 116 are installed as the plurality of network devices, and are identified with device identifiers NIC-A, NIC-B, NIC-C, and NIC-D, respectively. Further, as the plurality of virtual network devices, there are included virtual NICs (VNIC) 117, 118.

The plurality of network devices included in the server 101 and the physical server 102 can also be host bus adapters (HBA). The server 101 is equipped with the host bus adapters (HBA) 141, 142 as the network devices to be connected to a storage device 151, and the host bus adapters 141, 142 are identified with identifiers HBA1, HBA2, respectively.

The physical server 102 is equipped with HBAs 143, 144 to be connected to a storage device 152, the HBAs 143, 144 are identified with identifiers HBA-A, HBA-B, respectively. Further, the virtual server 122 operating in the physical server 102 is equipped with virtual HBAs (VHBA) 145, 146 as the virtual network devices.

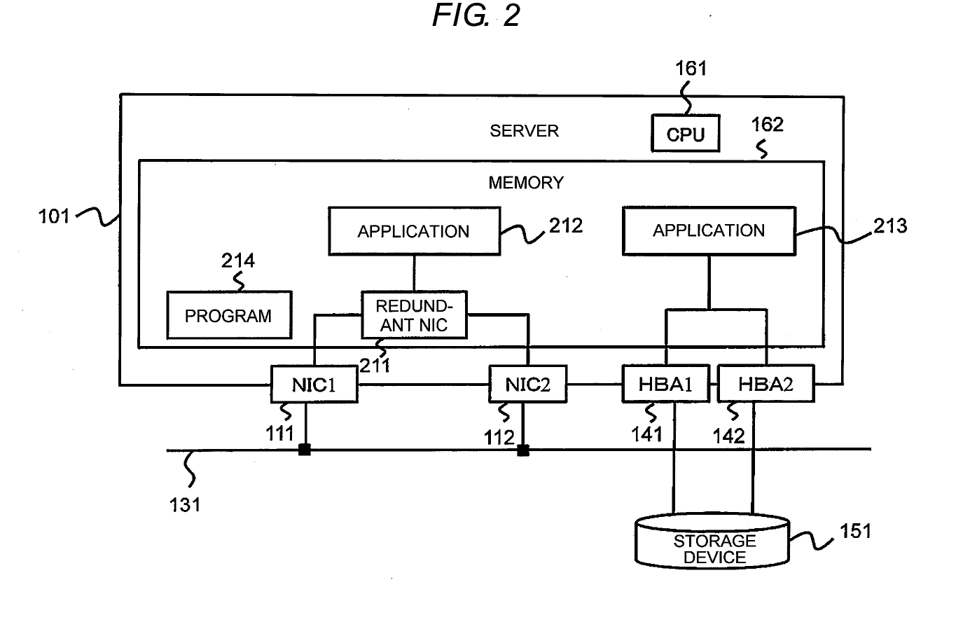

FIG. 2 is a diagram showing a configuration of the server 101. The server 101 includes the CPU 161 and the memory 162. The memory 162 stores a redundant NIC 211. The redundant NIC 211 denotes a virtual NIC obtained by putting the NICs 111, 112 installed in the server 101 together into a whole. The redundant NIC 211 is realized by the CPU 161 executing a program 214, which is stored in the memory 162, based on the setting (hereinafter described as redundant setting) of providing the NIC 111 and the NIC 112 with the redundant configuration.

Depending on the redundant setting, the redundant NIC 211 distributes the access load on the redundant NIC 211 between the NICs 111, 112, and in the case in which failures occur in the NIC 111, and thus the network access via the NIC 111 becomes unachievable, the redundant NIC 211 keeps the access to the network using the NIC 112. Further, the memory 162 includes an application 212 for accessing the network segment 131 using the redundant NIC 211.

Further, the server 101 includes an application 213 stored in the memory 162, and the HBAs 141, 142 to be connected to the storage device 151. The HBAs 141, 142 constitute the redundant configuration, and the access of the application 213 to the storage device 151 is distributed between the HBAs 141, 142. Further, besides the above, in the case in which failures occur in the HBA 141 and thus the access to the storage device 151 via the HBA 141 becomes unachievable, the access to the storage device 151 is kept using the HBA 142, for example.

A method and a configuration of making the virtual server 122 inherit the redundant configuration of the network devices, for example NICs 111, 112, of the server 101 in the case of transferring the system established on the server 101 taking the server 101 as a transfer source server will be explained.

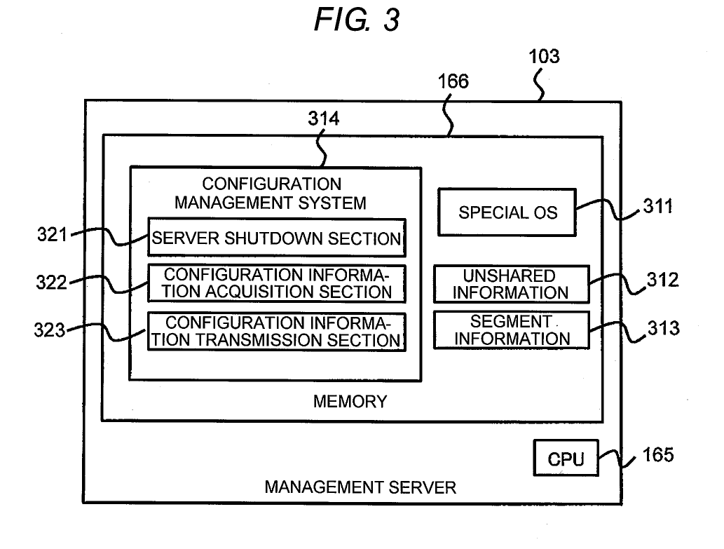

FIG. 3 is a diagram showing a configuration of the management server 103. The management server 103 includes the CPU 165 and the memory 166. The memory 166 stores a special OS 311, unshared information 312, segment information 313, and a configuration management system 314. The configuration management system 314 includes a server shutdown section 321, a configuration information acquisition section 322, and a configuration information transmission section 323, and is executed by the CPU 165.

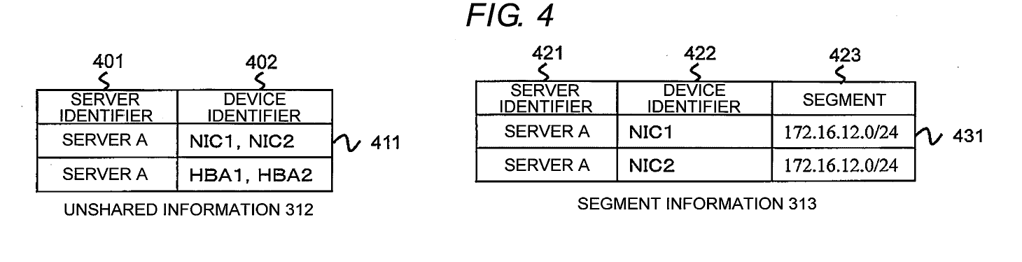

FIG. 4 shows the unshared information 312 and the segment information 313. The unshared information 312 is the information including the identifiers NIC1, NIC2 of the network devices, namely the NICs 111, 112, on which the redundant setting is performed, and for making NIC1, NIC2 unshared. Further, the unshared information 312 is the information including the identifiers HBA1, HBA2 of the network devices, namely the HBAs 141, 142, on which the redundant setting is performed, and for making HBA1, HBA2 unshared.

The unshared information 312 can be a list as shown in FIG. 4, and includes a server identifiers 401 and a device identifiers 402. For example, a row 411 of the unshared information 312 indicates that the network device (the NIC 111) identified with the device identifier NIC1 and the network device (the NIC 112) identified with the device identifier NIC2, which are installed in the server (the server 101) identified with the server identifier of server A, have the redundant configuration. In other words, the row 411 indicates that NIC1 and NIC2 are not allowed to share the same network device.

It should be noted that as the device identifier, there is used the value with which the device can uniquely identified in the server, such as an identification number of the device in the server, the MAC address, or a combination of the bus number, the device number, and the function ID.

The segment information 313 is the information for identifying the segment of the network to which the network devices NICs 111, 112 provided to the server 101 are connected. The segment information 313 can be a list as shown in FIG. 4, and includes a server identifiers 421, a device identifiers 422, and segments 423.

For example, a row 431 of the segment information 313 indicates that the server (the server 101) identified with the server identifier of server A includes the network device (the NIC 111) identified with the device identifier NIC1, and the network device (the NIC 111) identified with the device identifier NIC1 is connected to the segment 172.16.12.0/24. It should be noted that in the case in which the target network device is the HBA, which is the device for connecting the storage device, the segment information is not handled.

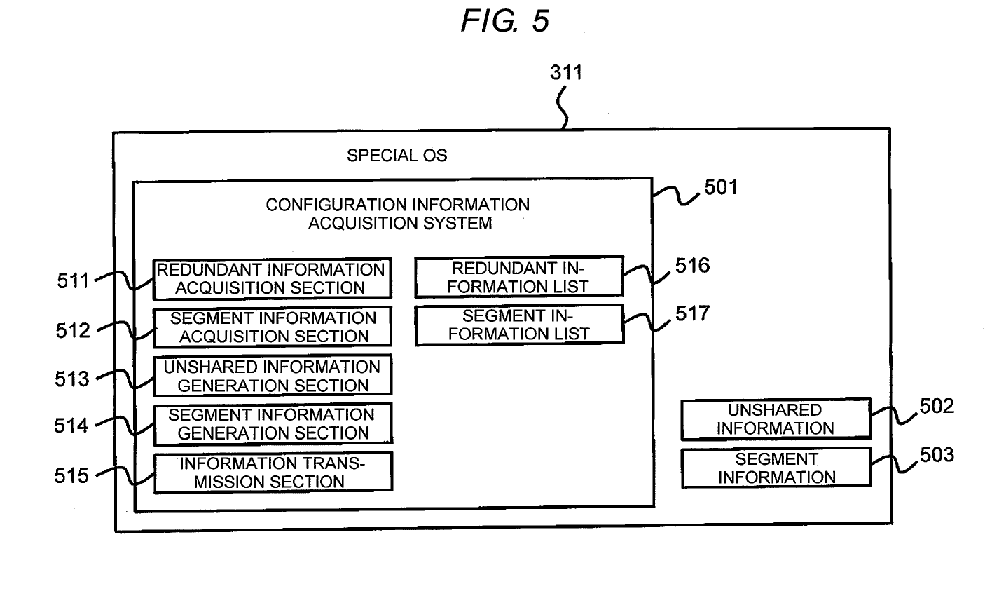

FIG. 5 is a diagram showing a configuration of the special OS 311. The special OS 311 includes a configuration information acquisition system 501, unshared information 502, and segment information 503. The configuration information acquisition system 501 includes a redundant information acquisition section 511, a segment information acquisition section 512, an unshared information generation section 513, a segment information generation section 514, an information transmission section 515, a redundant information list 516, and a segment information list 517. It should be noted that the unshared information 502 and the segment information 503 have substantially the same configurations as those of the unshared information 312 and the segment information 313, respectively.

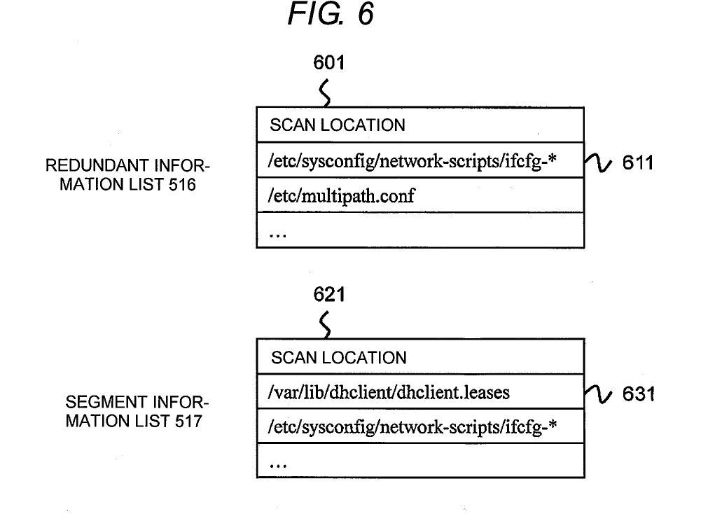

FIG. 6 shows the redundant information list 516 and the segment information list 517. The redundant information list 516 stores scan locations 601. The scan location 601 denotes the location where the redundant information acquisition section 511 scans when obtaining the redundant information.

Here, the redundant information denotes information having a redundant configuration in the plurality of network devices shown in the row 411 of the unshared information 312 described above. Further, scanning denotes a process of finding out certain data from a file designated. For example, the reference numeral 611 represents that the redundant information acquisition section 511 obtains the redundant information from /etc/sysconfig/network-scripts/ifcfg-*. The file designated is, for example, a file provided to the server 101, and is stored in the storage section provided to the server 101.

The segment information list 517 stores scan locations 621. The scan location 621 denotes the location where the segment information acquisition section 512 scans when obtaining the information of the segment. The segment is one of the units of networks in a local area network (LAN), and denotes a range reached by a packet transmitted from a certain device without conditions. For example, the reference numeral 631 represents that the segment information acquisition section 512 obtains the information of the segment from /var/lib/dhclient/dhclient.leases. The file to be scanned is, for example, a file provided to the server 101, and is stored in the storage section provided to the server 101.

It should be noted that it is possible that some value has previously been described in the scan locations 601, 621 of the redundant information list 516 and the segment information list 517, or it is also possible for the user (administrator) to describe a value later.

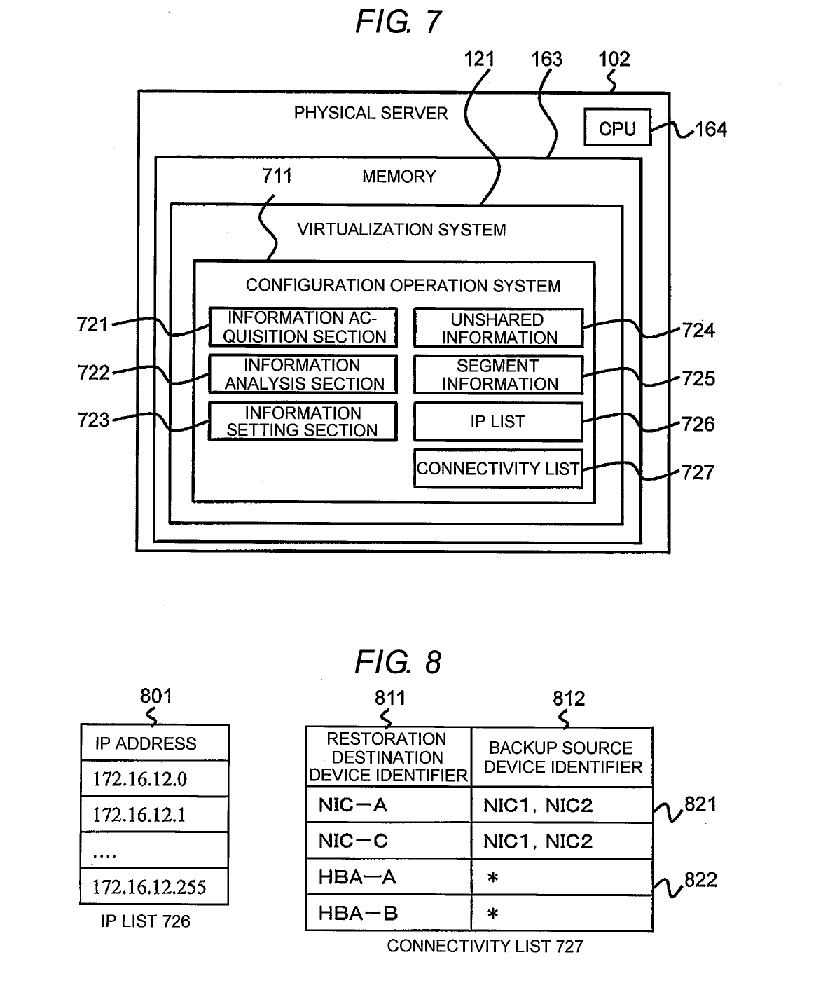

FIG. 7 is a diagram showing a configuration of the physical server 102. The virtualization system 121 is stored in the memory 163, and is executed by the CPU 164. The memory 163 stores correspondence information and a configuration operation system 711. The configuration operation system 711 includes an information acquisition section 721, an information analysis section 722, an information setting section 723, unshared information 724, segment information 725, an IP list 726, and a connectivity list 727. It should be noted that the unshared information 724 has substantially the same configuration as that of the unshared information 312. Further, the segment information 725 has substantially the same configuration as that of the segment information 313.

FIG. 8 shows the IP list 726 and the connectivity list 727. The IP list stores the IP addresses having a range designated by the segments 423 of the segment information 725. For example, in the case of the segment stored in a column 801 of the IP list 726, the range of the IP address is from 172.16.12.0 to 172.16.12.255.

The connectivity list 727 stores restoration destination (transfer destination) device identifiers 811 and backup source (transfer source) device identifiers 812. For example, a row 821 of the connectivity list 727 represents that the network device (NIC 113), which is provided to the physical server 102 as the restoration destination (transfer destination), and is identified with the restoration destination device identifier NIC-A, is connected to the network segment, which is connected to the network device (NIC 111) identified with the backup source device identifier NIC1 and the network device (NIC 112) identified with the backup source device identifier NIC2, and is therefore accessible.

Further, a row 822 of the connectivity list 727 represents that the host bus adapter (HBA 143) identified with the restoration destination device identifier HBA-A does not have a limitation on the backup source device to be allocated.

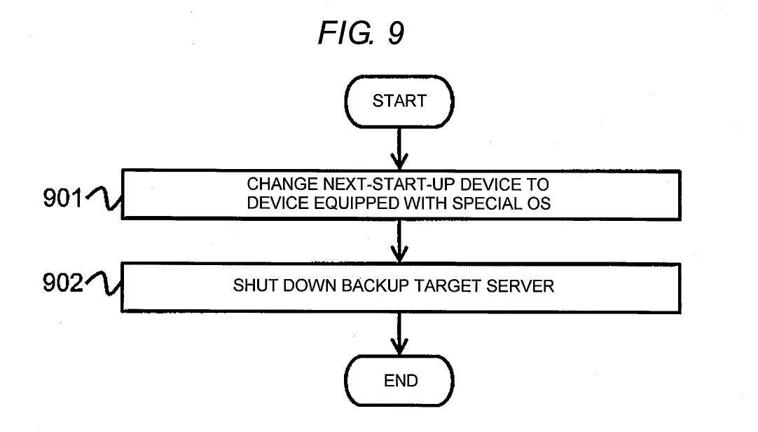

FIG. 9 shows a flowchart of the shutdown process executed by the server shutdown section 321. When the user starts the backup of the server 101, the server shutdown section 321 of the management server 103 receives a backup request of the server 101, changes (step 901) the device used when starting up the server 101 next time to a device equipped with the special OS, and then shuts down (step 902) the server 101 as the backup target.

By performing setting on the firmware of the server 101 in step 901, the device to be accessed for loading a boot program when starting up the server 101 next time is changed. For example, in the case in which the NIC 111 is selected as the device to be used when starting up next time, the firmware of the server 101 scans the inside of the network segment 131 to which the NIC 111 is connected at the time of startup to thereby detect the boot program. In the invention, it is assumed that the special OS 311 is detected as the boot program. The special OS 311 as the boot program thus detected is copied to the memory provided to the server 101, and then the server 101 is started up.

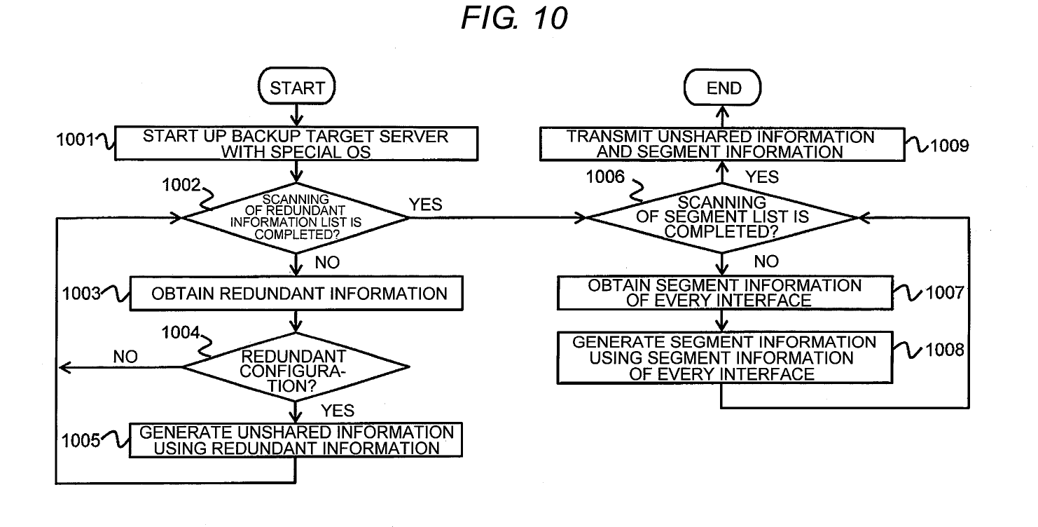

FIG. 10 shows a flowchart of an information acquisition process. After shutting down the server 101 as the backup target by the server shutdown section 321, the server 101 is started up (step 1001) with the special OS 311. Specifically, the configuration management system 314 transfers the special OS 311 as an operating system to the server 101, and then makes the special OS 311 operate. In the special OS 311, the configuration information acquisition system 501 operates. The redundant information acquisition section 511 of the configuration information acquisition system 501 scans (step 1002) the redundant information list 516.

If any of the scan location 601 remains unscanned in the redundant information list 516, the scan location is scanned, and the redundant information is obtained (step 1003).

In this step, for example, the redundant information list is scanned in the listed order. The scanning is assumed to be completed at the time point when the scanning of all of the information listed is completed.

If the redundant configuration is adopted in the scan location (step 1004), the unshared information 502 is generated or updated (step 1005) using the redundant information obtained by the unshared information generation section 513. Then, the redundant information list 516 is scanned again (step 1002).

If the redundant configuration is not adopted in the scan location in the step 1004, the redundant information list 516 is also scanned (step 1002).

In the step 1002, if the scanning of the redundant information list 516 is completed, the segment information acquisition section 512 scans (step 1006) the segment information list 517.

If any of the scan location 621 remains unscanned in the segment information list 517, the scan location is scanned, and the information of the segment is obtained (step 1007). The segment information 503 is generated (step 1008) using the information of the segment thus obtained by the segment information generation section 514, and then the segment information list 517 is scanned (step 1006) again.

It should be noted that in the case in which the target network device is the HBA, which is the device for connecting the storage device, the segment information is not handled. Therefore, the segment information 503 related to the HBA generated in the step 1008 is an empty list.

If the scanning of the segment information list 517 is completed in the step 1006, the information transmission section 515 transmits (step 1009) the unshared information 502 and the segment information 503 thus generated to the configuration information acquisition section 322 of the management server 103.

It should be noted that even in the state in which the server 101 is in operation, it is possible to generate the unshared information 502 and the segment information 503 on the memory 201, and then transmit the unshared information 502 and the segment information 503 to the management server 103 by making the configuration information acquisition system 501 operate on the server 101. In this case, if the backup request triggered by the backup starting operation by the user is received, the management server 103 provides the backup target server 101 with the configuration information acquisition system 501. The configuration information acquisition system 501 is developed on the memory of the server 101, and then executes the steps 1002, 1003, 1004, 1005, 1006, 1007, 1008, and 1009. It is possible to generate the unshared information 502 and the segment information 503 without halting the server 101.

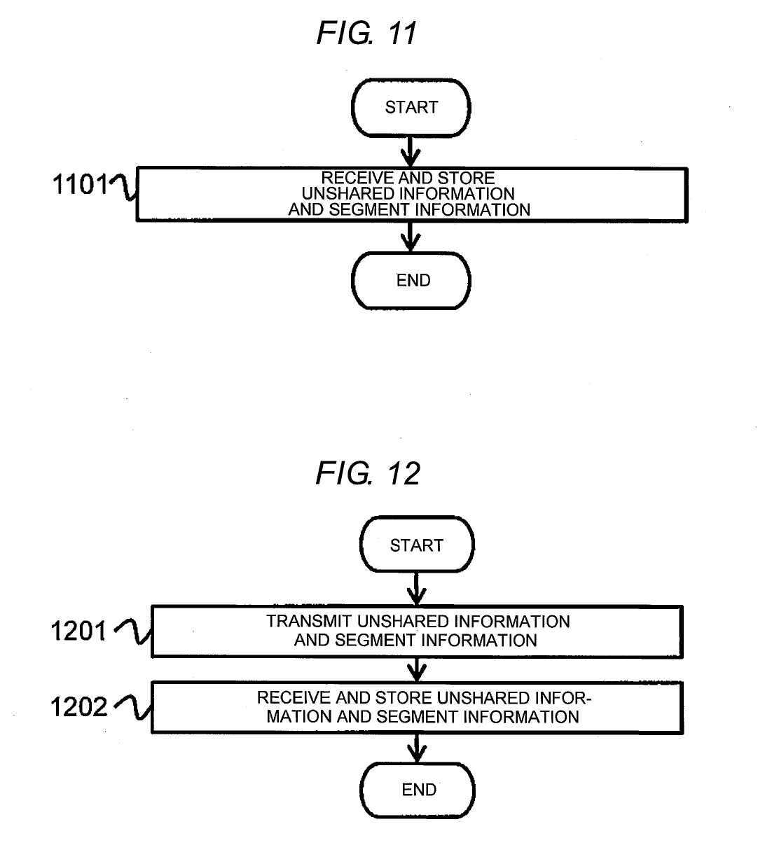

FIG. 11 shows a flowchart of a process of the configuration information acquisition section 322. The configuration information acquisition section 322 obtains the information of the unshared information 502 and the segment information 503 transmitted in the step 1009, and then stores (step 1101) the information into the unshared information 312 and the segment information 313, respectively.

FIG. 12 shows a flowchart of a process of the configuration information transmission section 323 and the information acquisition section 721. When the user starts the restoration process, the management server 103 receives the restoration request to the virtual server 122, and then the configuration information transmission section 323 of the management server 103 transmits (step 1201) the unshared information 312 and the segment information 313 to the virtualization system 121 of the physical server 102 as the restoration destination. The information acquisition section 721 obtains the unshared information 312 and the segment information 313, and then stores (step 1202) the information to the unshared information 724 and the segment information 725, respectively.

Here, the backup request of the server 101 in the step 901 and the restoration request in the step 1201 received by the management server 103 are the request to transfer the system operating in the server 101 to the virtual server 122 established on the physical server 102.

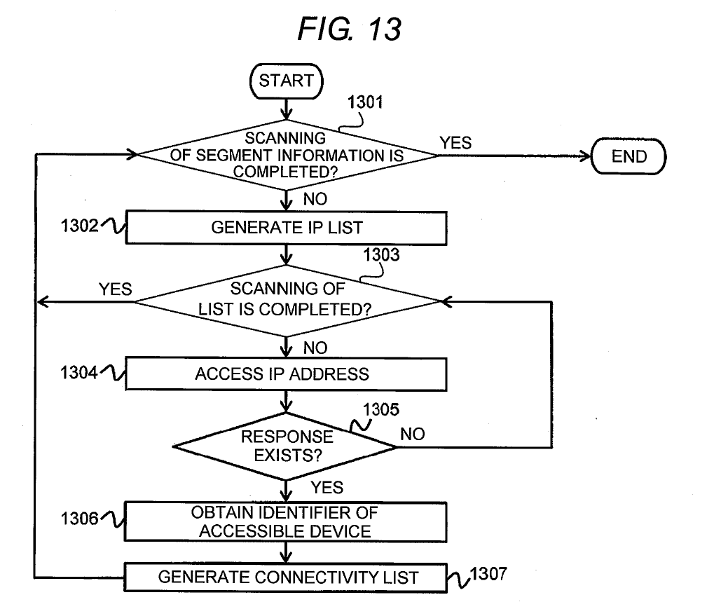

FIG. 13 shows a flowchart of a process of the information analysis section 722. When the unshared information 724 and the segment information 725 are obtained in the step 1202, the information analysis section 722 obtains (step 1301) the information 431 of the device, which is to be checked on whether or not the access to the segment is allowable, from the segment information 725. The information analysis section 722 obtains the IP address included in the segment from the information 423 of the segment in the information 431 of the device, and then generates (step 1302) the IP list 726.

The information analysis section 722 scans the IP list 726 thus generated to obtain (step 1303) the IP address to be checked on whether or not the access is allowable. The information analysis section 722 issues (step 1304) an access request to the device provided with the IP address.

As a result of the step 1304, if the response to the access request is obtained from the device, it is indicated that the network device installed in the physical server 102 used for the access is connected to the device on the network to which the network devices NICs 111, 112 of the server 101 are connected (step 1305).

For example, in the step 1304, a PING command can be executed to the IP. In this case, it is assumed in the step 1305 that the response is present if ACK is returned, and the response is absent if ACK is not returned.

If the response to the access request is obtained from the device, information analysis section 722 obtains (step 1306) the restoration destination device identifier of the network device installed in the physical server 102 used for the access to the device provided with the IP address in the step 1304.

The information analysis section 722 generates or updates (step 1307) the connectivity list 727 using the restoration destination device identifier thus obtained and the backup source device identifier 422 obtained from the information 431 of the device obtained in the step 1301. The information analysis section 722 performs (step 1301) the scanning of the segment information again.

In the step S1301, if the scanning of all of the information listed in the segment information 725 is completed, the information analysis section 722 terminates the process.

It should be noted that if the scanning of all of the information listed in the IP list 726 is completed in the step 1303, the process returns to the step 1301. Further, in the step 1305, if the response fails to be obtained from the device provided with the IP address to which the access request is issued in the step 1304, the process returns to the step 1303.

Further, in the case in which the target network device is the HBA, which is the device for connecting the storage device, the segment information 725 is empty. Therefore, the process of the step 1301 is terminated without performing the process on and after the step 1302.

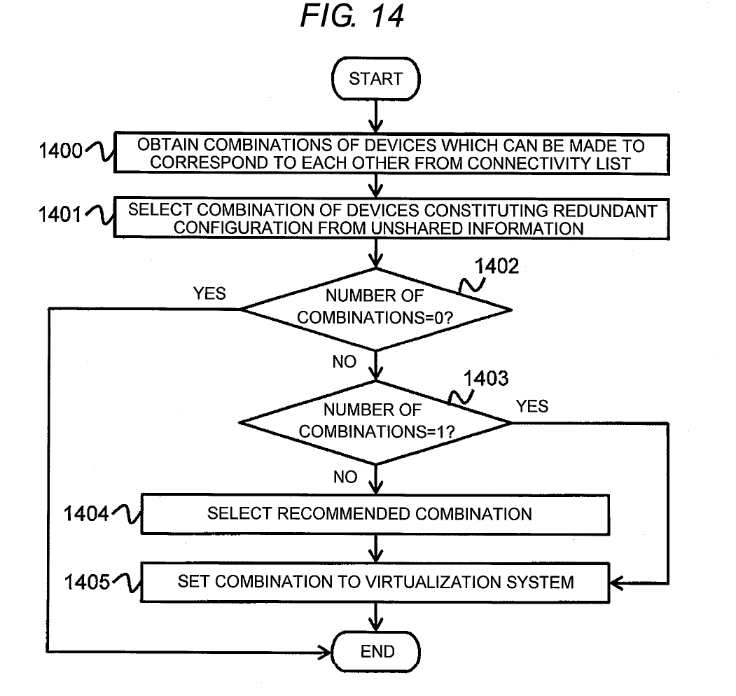

FIG. 14 shows a flowchart of a process of the information setting section 723. In the step 1400, the information setting section 723 obtains the combination to be connected to the network segment requested by the server 101 as the backup source out of the combinations of the network devices of the physical server 102 and the virtual network devices of the virtual server 122 from the connectivity list 727.

For example, it is understood from the connectivity list 727 that the network devices, which can be selected on the physical server 102 as the network devices to be connected to the network segment requested by the server 101 as the backup source, are the NIC 113 identified with NIC-A and the NIC 115 identified with NIC-C.

Therefore, according to the connectivity list 727, the combinations of {virtual network devices recognized by the virtual server 122}={network devices installed in the corresponding physical server 102} are {NIC1, NIC2}={NIC-A, NIC-A}, {NIC-A, NIC-C}, {NIC-C, NIC-A}, and {NIC-C, NIC-C}.

In the step 1401, in order to make the virtual server 122 inherit the redundant configuration of the network device of the server 101, the information setting section 723 detects the NICs, to which the same network device is not allowed to be allocated, from the unshared information 724.

For example, it is understood that the same network device is not allowed to be allocated to NIC1 and NIC2. Therefore, the combinations which can be set to the virtual server 122 are {NIC1, NIC2}={NIC-A, NIC-C} and {NIC-C, NIC-A}.

If the number of the combinations obtained in the step 1401 is 0 (step 1402), it is understood that the access from the virtual server 122 to the segment, to which the access has been achieved on the server 101, is unachievable, or that reproduction of the redundant configuration, which has been established on the server 101, is unachievable on the virtual server 122. The information setting section 723 determines that it is unachievable to restore the backup obtained by the server 101 as the virtual server 122, and then terminates the process.

If the number of the combinations obtained in the step 1401 is equal to or larger than 2 (step 1403), the information setting section 723 selects (step 1404) a recommended combination. As the selection rule, it is possible to adopt a method of equalizing the number of virtual network devices recognized by the virtual server 122 to be allocated to the network device with the aim of equalization of the flow rate of the network device installed in the restoration destination physical server 102. It is also possible to add another rule.

The information setting section 723 sets the combination obtained in the step 1404 to the virtualization system 121. Specifically, the virtualization system 121 sets the identifiers NIC1, NIC2 as the identifiers of the virtual network devices, namely VNICs 117, 118 with reference to the unshared information 724.

Then, the virtualization system 121 stores the correspondence information for separately making correspondences between the VNICs 117, 118 and the NIC 113 identified with NIC-A, and the NIC 115 identified with NIC-C in the memory. Due to the correspondence information, the VNICs 117, 118 are separately allocated to the NIC 113 and the NIC 115. If the number of combinations obtained in the step 1403 is 1, the combination thus obtained is set (step 1405) to the virtualization system 121.

Further, in the case in which the target network device is the HBA, which is the device for connecting the storage device, the information setting section 723 obtains the combination, with which the network device requested by the server 101 can be realized, out of the combinations of the HBA of the physical server 102 as the restoration destination and the virtual HBA of the virtual server 122 on the physical server 102 from the connectivity list 727 and the unshared information 724 in the step 1400. For example, according to the connectivity list 727, it is understood that devices, which can be selected on the physical server 102, are HBA-A and HBA-B.

Further, according to the unshared information 724, it is understood that it is not allowed to allocate the same device to the backup source device identifier HBA1 (the HBA 141) and the backup source device identifier HBA2 (the HBA 142). Therefore, the combinations of {virtual host bus adapter recognized by the virtual server 122}={host bus adapter installed in the corresponding physical server 102} are {HBA1, HBA2}={HBA-A, HBA-B} and {HBA-B, HBA-A} (step 1401).

If the number of the combinations obtained in the step 1401 is equal to or larger than 2 (step 1403), the information setting section 723 selects (step 1404) a recommended combination.

The information setting section 723 sets the combination obtained in the step 1404 to the virtualization system 121. Specifically, the virtualization system 121 sets the identifiers HBA1, HBA2 as the identifiers of the virtual network devices, namely VHBAs 145, 146 with reference to the unshared information 724.

Then, the virtualization system 121 stores the correspondence information for separately making correspondences between the VHBAs 145, 146 and the HBA 143 identified with HBA-A, and the HBA 144 identified with HBA-B in the memory (step 1405).

It should be noted that the configuration operation system 711 can be made to operate on the virtual server 122 operating on the virtualization system 121 instead of the virtualization system 121 itself.

Further, it is also possible for the human to execute the processes performed by the configuration management system 314, the configuration information acquisition system 501, and the configuration operation system 711 using commands and so on.

According to the configuration described hereinabove, substantially the same environment as the network device environment of the backup source server can be established on the restoration destination server. By copying the OS environment of the backup source to the restoration destination, the restoration process can be completed.

What is claimed is:

1. A server comprising:
a CPU;
a plurality of network devices; and
a virtualization system
adapted to obtain unshared information including identifiers used to identify a first network device and a second network device provided with a redundant setting provided to a transfer source server, and making the first and second network devices unshared,
adapted to set the identifiers used to identify the first and second network devices as identifiers of a first virtual network device and a second virtual network device provided to a virtual server including a plurality of virtual network devices with reference to the unshared information obtained, and
adapted to make the first and second virtual network devices, to which the identifiers are set, correspond separately to the network devices.

2. The server according to claim 1, wherein
the plurality of network devices provided to the server is connected to a device on a network, to which the first and second network devices provided to the transfer source server are connected.

3. The server according to claim 1, wherein
the virtualization system obtains segment information used to identify a segment of a network to which the first and second network devices are connected, and makes a plurality of network devices, which is to be connected to the segment identified with the segment information obtained, out of the plurality of network devices provided to the server correspond separately to the first and second virtual network devices.

4. A management server comprising:
a memory adapted to store an operating system; and
a CPU adapted to perform a configuration management system which transfers the operating system to a first server and then makes the operating system operate in response to receiving a request to transfer a system, which operates in the first server including a first network device and a second network device provided with a redundant setting, to a virtual server established on a second server, obtains unshared information including identifiers of the first and second network devices, and making the first and second network devices unshared, and transmits the unshared information obtained to the second server.

5. The management server according to claim 4, wherein
the configuration management system transfers the operating system to the first server and then makes the operating system operate, obtains segment information used to identify a segment of a network which can be accessed by the first and second network devices, and transmits the segment information obtained to the second server.

6. A method of setting a network device in a computer system, the method comprising:
(a) obtaining, by a virtualization system of a second server, unshared information including identifiers used to identify a first network device and a second network device provided with a redundant setting provided to a first server, and making the first and second network devices unshared;
(b) setting, by the virtualization system, the identifiers of the first and second network devices as identifiers of a first virtual network device and a second virtual network device provided to a virtual server including a plurality of virtual network devices with reference to the unshared information obtained; and
(c) making, by the virtualization system, the first and second virtual network devices, to which the identifiers are set, correspond separately to the network devices provided to the second server.

7. The method of setting a network device in a computer system according to claim 6, wherein
the plurality of network devices provided to the second server is connected to a device on a network, to which the first and second network devices provided to the first server are connected.

8. The method of setting a network device in a computer system according to claim 6, wherein
the virtualization system obtains segment information used to identify a segment of a network to which the first and second network devices are connected, and makes a plurality of network devices, which is to be connected to the segment identified with the segment information obtained, out of the plurality of network devices provided to the second server correspond separately to the first and second virtual network devices.

9. The method of setting a network device in a computer system according to claim 6, wherein
when a management server connected to the first server and the second server receives a request to transfer a system operating in the first server to a virtual server established on the second server,
a configuration management system of the management server makes an operating system operate on the first server to obtain the unshared information, and transmits the unshared information obtained to the second server.

10. The method of setting a network device in a computer system according to claim 8, wherein
the configuration management system makes an operating system operate on the first server to obtain the segment information, and transmits the segment information obtained to the second server.
